(19) United States
(12) Patent Application Publication
(10) Pub. No.: US 2006/0155971 A1
(43) Pub. Date: Jul. 13, 2006

(54) Transmission of a digital message between a microprocessor monitoring circuit and an analysis tool

(75) Inventors: Catherine Robert, Tokyo (JP); Xavier Robert, Saint Georges De Commiers (FR); Jehan-Philippe Barbiero, Vizille (FR)

Correspondence Address: STMicroelectronics Inc.;c/o WOLF, GREENFIELD & SACKS, PC, Federal Reserve Plaza, 600 Atlantic Avenue, BOSTON, MA, 02210-2206, US

(73) Assignee: STMicroelectronics S.A., Montrouge (FR)

(21) Appl. No.: 10/535,065

(22) PCT Filed: Nov. 14, 2002
(86) PCT No.: PCT/FR02/03908

§ 371 Date: Oct. 24, 2005

(51) Int. Cl. G06F 9/44

(52) U.S. Cl. 712/227

(57) ABSTRACT

The invention relates to a method for the transmission of digital messages by a monitoring circuit (18) which is integrated into a microprocessor (12), said method being performed during the execution of a series of instructions by the microprocessor. Moreover, at least one of said digital messages represents the detection of a jump in the execution of the series of instructions from a source instruction to a destination instruction. The inventive method consists in determining whether or not the jump is associated with a jump instruction from the series of instructions for which the address of the jump destination instruction is explicitly indicated in the instruction. If the answer is in the affirmative, a first value is allocated to a first set of bits or, if the answer is in the negative, a second value is allocated to the first set of bits. Finally, if the first set of bits has been allocated the second value, a third value is allocated to a second set of bits of the digital message, said third value identifying the jump among several types of jumps.

The present invention relates to the testing of microprocessors. It more specifically relates to a method and device of digital data transmission between a monitoring circuit integrated in a microprocessor chip and an analysis tool.

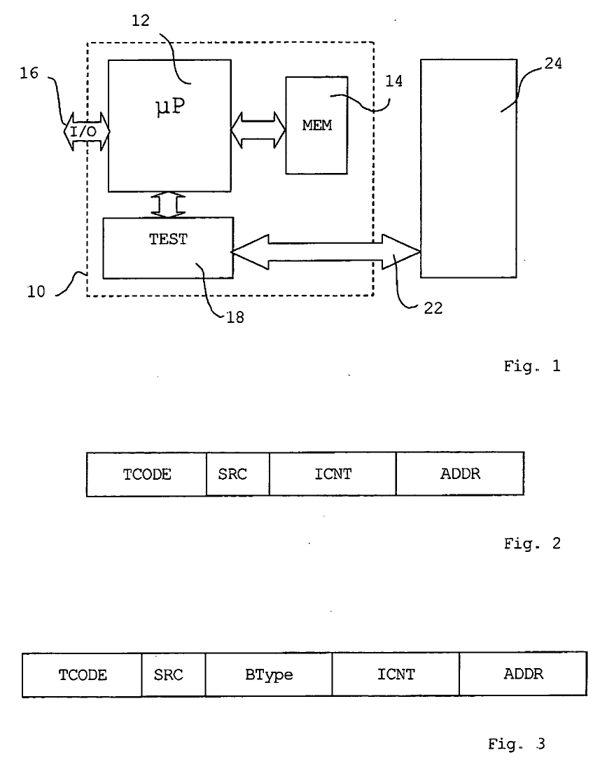

FIG. 1 schematically shows an integrated circuit 10 comprising a microprocessor (μP) 12, an internal memory (MEM) 14, and input/output terminals (I/O) 16. Microprocessor 12 is intended to execute a program or a software stored in memory 14. Under control of the program, microprocessor 12 may process data provided by input/output terminals 16 or stored in memory 14 and read or write data through input/output terminals 16.

To check the proper operation of the microprocessor, a monitoring circuit 18 (TEST) is generally integrated to integrated circuit 10. Monitoring circuit 18 is capable of reading specific data provided by microprocessor 12 on execution of a program, and of possibly processing the read data. Monitoring terminals 22 connect monitoring circuit 18 to an analysis tool 24. Analysis tool 24 may process the received signals, for example, according to commands provided by a user, and ensure a detailed analysis of the operation of microprocessor 12. In particular, analysis tool 24 may determine the program instruction sequence really executed by microprocessor 12.

The number of monitoring terminals 22 for a conventional monitoring circuit 18 may be on the same order of magnitude as the number of input/output terminals 16 of microprocessor 12, for example, from 200 to 400. Monitoring terminals 22 as well as the connections of monitoring circuit 18 take up a significant silicon surface area, which causes an unwanted increase in the circuit cost. For this purpose, a first version of integrated circuit 10 comprising monitoring circuit 18 and monitoring terminals 22 is produced in small quantities to check out microprocessor 12. After this checking out, a version of integrated circuit 10 rid of monitoring circuit 18 and of monitoring terminals 22 is sold. This implies the forming of two versions of the integrated circuit, which requires a significant amount of work and is relatively expensive. Further, the final chip is not identical to the tested chip.

To overcome the above-mentioned disadvantages, it is desired to form a monitoring circuit 18 which takes up a reduced surface area and only requires a reduced number of monitoring terminals 22, which decreases the cost of monitoring circuit 18. Monitoring circuit 18 can then be left on the finally sold integrated circuit 10.

It is thus desired to decrease the number of signals provided by monitoring circuit 18. For this purpose, certain logic operations are directly performed at the level of monitoring circuit 18 on the data measured at the level of microprocessor 12 to only transmit messages having an important information content.

Thus, standard IEEE-ISTO-5001 in preparation provides in its 1999 version, accessible, for example, on website www.ieee-isto.org/Nexus5001, a specific message exchange protocol between a monitoring circuit 18 and an analysis tool 24 for a monitoring circuit 18 requiring only a reduced number of monitoring terminals 22.

Among the messages according to standard IEEE-ISTO-5001 provided by monitoring circuit 18, a message, called a jump message, indicates the occurrence of a jump in the program executed by microprocessor 12. A jump corresponds to the passing from an initial instruction which has just been executed by the program to a destination instruction other than the instruction that follows the initial instruction in the instruction sequence forming the program. Based on the jump message transmitted by monitoring circuit 18, analysis tool 24 attempts to reconstitute the instruction sequence executed by microprocessor 12. The sequence of reconstituted instructions can then be compared to an instruction sequence theoretically executed by microprocessor 12 to determine errors in the operation of microprocessor 12.

FIG. 2 shows a general example of a digital message transmitted by monitoring circuit 18 according to standard IEEE-ISTO-5001. The message comprises a sequence of fields, each corresponding to a fixed or variable number of bits. In FIG. 2, the least significant bits of the message are located to the left of the drawing, and the most significant bits are located to the right of the drawing. For each field having a variable number of bits, the most significant bits which are at zero are generally suppressed on transmission of the digital message. A first field Tcode shows an identifier of the message. For each given identifier, the number of fields forming the message is fixed.

Standard IEEE-ISTO-5001 provides two possible identifiers for jump messages. A first identifier corresponds to a so-called “explicit” jump. An explicit jump results from an direct jump instruction executed by microprocessor 12 which causes a jump to a program instruction having its address, or data representative of its address, explicitly indicated in the jump instruction. A second identifier corresponds to the other jump types, called “implicit jumps”, that may occur on execution of a program by microprocessor 12.

For the two possible identifiers, the jump message comprises a second field SRC comprising a variable number of bits according to the use of monitoring circuit 18. Field SRC is used when monitoring circuit 18 simultaneously exchanges data with several microprocessors or when monitoring circuit 18 exchanges data with a same microprocessor 12 which simultaneously executes several programs. When monitoring circuit 18 is not intended to operate in the two previously-mentioned cases, field SRC may comprise no bit.

For the two jump identifiers, the jump message comprises a third field ICNT comprising a variable number of bits and corresponding to the number of instructions executed by microprocessor 12 since the last executed instruction for which monitoring circuit 18 has transmitted an explicit or implicit jump message.

In the case of an implicit jump, the jump message comprises a fourth field ADDR comprising a variable number of bits and representing the address of the jump destination instruction. The value of field ADDR corresponds, for example, to the difference between the address of the destination instruction and the address of the last instruction executed by microprocessor 12.

A disadvantage is that the implicit jump message provided by standard IEEE-ISTO-5001 may correspond to jumps which occur in very different contexts. Indeed, an implicit jump may result from an indirect jump instruction of the program executed by microprocessor 12. An indirect jump instruction is a jump instruction which does not comprise data representative of the address of the jump destination instruction, but a reference to a register in which is stored said representative data. An implicit jump may also correspond to a jump imposed by the actual structure of microprocessor 12. A jump is then performed although the last instruction of the program executed by microprocessor 12 is not an indirect jump instruction. Interrupt jumps and circuit jumps are distinguished. An interrupt corresponds, when certain interrupt triggering conditions are fulfilled, to a forced stop of the program execution, to the execution of an interrupt routine, then to the possible resuming of the program execution. An interrupt jump thus occurs from a program instruction to the first instruction of the interrupt routine. An example of an interrupt triggering condition is the reception by the microprocessor of a signal indicating that the charge level of batteries supplying microprocessor 12 is below a determined threshold. A circuit jump corresponds to a jump imposed by the very structure of microprocessor 12 when certain conditions are fulfilled from an initial instruction of the program to a destination instruction also belonging to the program. Circuit jumps are frequently used to perform the repetition of a small number of instructions a number of times by microprocessor 12.

The jump messages provided by standard IEEE-ISTO-5001 and transmitted to analysis tool 24 by monitoring circuit 18 may cause ambiguities on reconstitution by analysis tool 24 of the instruction sequence really executed by the program. Indeed, when analysis tool 24 receives an explicit jump message, it deduces therefrom that a direct jump instruction has been executed by microprocessor 12. It is then easy to associate the direct jump instruction in the instruction sequence reconstituted by analysis tool 24 with the corresponding direct jump instruction of the instruction sequence theoretically executed by microprocessor 12.

When analysis tool 24 receives an implicit jump message, it cannot determine whether the implicit jump message corresponds to an indirect jump message executed by microprocessor 12 or to a jump imposed by microprocessor 12 and which is not associated with a jump instruction of the program. Indeed, in the case where the instruction of the instruction sequence reconstituted by analysis tool 24 corresponding to the message received by analysis tool 24 is not an indirect jump instruction, it is not possible in sure fashion to determine whether the received implicit jump message corresponds to an indirect jump and whether the instruction sequence reconstituted by analysis tool 24 is incorrect, for example shifted with respect to the instruction sequence really executed by microprocessor 12.

The present invention provides a digital message transmission method enabling limiting certain ambiguities on reconstitution by the analysis tool of the instruction sequence executed by the microprocessor whatever the type of jump performed by the microprocessor.

The present invention further provides a digital message transmission method which only slightly modifies the jump messages provided by standard IEEE-ISTO-5001.

To achieve these objects, the present invention provides a method for transmitting digital messages, on execution of an instruction sequence by the microprocessor, through output terminals of a monitoring circuit integrated to the microprocessor, at least one of said digital messages being representative of characteristic data stored by the monitoring circuit on detection of a jump in the execution of the instruction sequence from an initial instruction to a destination instruction different from the instruction following the initial instruction in the instruction sequence, the method comprising the steps of, for the transmission of a digital message, determining whether the jump is associated with a jump instruction of the instruction sequence for which data representative of the destination instruction address of the jump is explicitly indicated in the instruction; if so, assigning a first value to a first set of bits of the digital message, and if not, assigning a second value to the first set of bits; if the first set of bits is at the second value, assigning to a second set of bits of the digital message a third value identifying the jump from among several types of jumps; and transmitting the digital message.

According to an object of the present invention, the method further comprises the step of assigning to a third set of bits of the digital message a value corresponding to the number of instructions executed by the microprocessor since the last executed instruction of the instruction sequence corresponding to a digital message associated with a jump.

According to an object of the present invention, the method further comprises the step of, if the first set of bits is at the second value, assigning to a fourth set of bits of the digital message a value representative of the address of the destination instruction.

According to an object of the present invention, a jump type corresponds to a jump resulting from a jump instruction of the instruction sequence containing the reference of a register in which are stored data representative of the destination instruction address.

According to an object of the present invention, a jump type corresponds to a jump forced by the microprocessor, the destination instruction corresponding to an instruction of a series of specific instructions which does not belong to the instruction series.

According to an object of the present invention, a jump type corresponds to a jump forced by the microprocessor, the destination instruction being an instruction of the instruction sequence.

The present invention also provides a device for transmitting digital messages between a monitoring circuit integrated to a microprocessor and an analysis tool via output terminals comprising means of detection of a jump on execution of an instruction sequence by the microprocessor; means for storing data characteristic of the detected jump; means for determining a digital message based on the stored characteristic data, the digital message comprising a first set of bits set to a first value if the jump is associated with a jump instruction of the instruction sequence for which data representative of the destination instruction address of the jump are explicitly indicated in the instruction, and set to a second value in the opposite case; and means for transmitting the determined digital message in which, when the first set of bits is set to the second value, the determination means is capable of comprising a second set of bits in the digital message set to a third value identifying the jump from among several jump types.

The foregoing and other objects, features, and advantages of the present invention will be discussed in detail in the following non-limiting description of specific embodiments in connection with the accompanying drawings, among which:

FIG. 1, previously described, very schematically shows the architecture of a conventional chip integrating a microprocessor and a monitoring device;

FIG. 2 shows an example of a conventional implicit message sent by a monitoring circuit; and

FIG. 3 shows an example of an implicit jump message sent by a monitoring circuit according to the present invention.

For explicit jumps, that is, jumps associated with a program jump instruction for which data representative of the destination instruction address of the jump are explicitly indicated in the instruction, the present invention provides keeping the explicit jump message already provided by standard IEEE-ISTO-5001. For implicit jumps, that is, all the other possible jump types, for example, indirect jumps, interrupt jumps, and circuit jumps, the present invention provides adding to the implicit jump message provided by standard IEEE-ISTO-5001 an additional field specifying the nature of the implicit jump to modify as little as possible standard IEEE-ISTO-5001.

FIG. 3 shows an example of an implicit jump message according to the present invention. The message comprises, on the least significant bit side, field Tcode which, as explained previously, has a specific value for an implicit jump. The implicit jump message comprises a second field SRC which, as explained previously, comprises a variable number of bits and indicates whether monitoring circuit 18 is connected at the same time to several microprocessors or whether monitoring circuit 18 is connected to a same microprocessor simultaneously executing several programs.

The implicit jump message according to the present invention comprises a third field BType having a variable number of bits and indicating the different possible implicit jumps. As an example, field BType may comprise two bits, which enables coding a first value corresponding to a jump resulting from an indirect jump instruction, a second value corresponding to a jump resulting from an interrupt, and a third value corresponding to a circuit jump. The number of bits depends on the number of implicit jump types that are desired to be distinguished by analysis tool 24.

As explained previously, the implicit jump message also comprises a third field ICNT. Field ICNT comprises a variable number of bits and is equal to the number of instructions which separates the instruction executed by microprocessor 12 to which a jump has been performed from the last instruction executed by the program having caused the transmission of a jump message by monitoring circuit 18. The implicit jump message finally comprises a fourth field ADDR corresponding to data representative of the destination instruction address of the jump. For example, in the case where the jump results from an interrupt, field ADDR generally designates an instruction of a routine stored in memory 14 which does not belong to the program executed by microprocessor 12.

From an implicit jump message according to the present invention provided by monitoring circuit 18, analysis tool 24 may differentiate the different implicit jump types to remove possible ambiguities on reconstitution of the instruction sequence executed by microprocessor 12.

The present invention has the advantage of modifying as little as possible the implicit jump message provided by standard IEEE-ISTO-5001. Indeed, it provides the addition of a single field of variable length in the message initially provided by standard IEEE-ISTO-5001, the other fields remaining unchanged.

1. A method for transmitting digital messages, on execution of an instruction sequence by the microprocessor, through output terminals of a monitoring circuit integrated to the microprocessor, at least one of said digital messages being representative of characteristic data stored by the monitoring circuit on detection of a jump in the execution of the instruction sequence from an initial instruction to a destination instruction different from the instruction following the initial instruction in the instruction sequence, comprising, for the transmission of a digital message, the steps of:
determining whether the jump is associated with a jump instruction of the instruction sequence for which data representative of the destination instruction address of the jump is explicitly indicated in the instruction;
if yes, assigning a first value to a first set of bits of the digital message, and if not, assigning a second value to the first set of bits;
if the first set of bits is at the second value, assigning to a second set of bits of the digital message a third value identifying the jump from among several types of jumps; and
transmitting the digital message.

2. The method of claim 1, further comprising the step of assigning to a third set of bits of the digital message a value corresponding to the number of instructions executed by the microprocessor since the last executed instruction of the instruction sequence corresponding to a digital message associated with a jump.

3. The method of claim 1, further comprising the step of, if the first set of bits is at the second value, assigning to a fourth set of bits of the digital message a value representative of the address of the destination instruction.

4. The method of claim 1, in which a jump type corresponds to a jump resulting from a jump instruction of the instruction sequence containing the reference of a register in which are stored data representative of the destination instruction address.

5. The method of claim 1, in which a jump type corresponds to a jump forced by the microprocessor, the destination instruction corresponding to an instruction of a series of specific instructions which does not belong to the instruction series.

6. The method of claim 1, in which a jump type corresponds to a jump forced by the microprocessor, the destination instruction being an instruction of the instruction sequence.

7. A device for transmitting digital messages between a monitoring circuit integrated on a microprocessor and an analysis tool via output terminals comprising:
means of detection of a jump on execution of an instruction sequence by the microprocessor;
means for storing data characteristic of the detected jump;
means for determining a digital message based on the stored characteristic data, the digital message comprising a first set of bits set to a first value if the jump is associated with a jump instruction of the instruction sequence for which data representative of the destination instruction address of the jump are explicitly indicated in the instruction, and set to a second value in the opposite case; and
means for transmitting the determined digital message;
wherein, when the first set of bits is set to the second value, the determination means is capable of comprising a second set of bits in the digital message set to a third value identifying the jump from among several jump types.
